(19) United States
(12) Patent Application Publication
(10) Pub. No.: US 2024/0327591 A1
(43) Pub. Date: Oct. 3, 2024

(54) PROCESS OF PREPARING POLYURETHANE ELASTOMER FOAM

(71) Applicant: BASF SE, Ludwigshafen am Rhein (DE)

(72) Inventors: Zhen Peng LIANG, Guangzhou Guangdong (CN); Bang Wei XI, Shanghai (CN); YingHao LIU, Shanghai (CN); Xin JIN, Shanghai (CN)

(21) Appl. No.: 18/577,034

(22) PCT Filed: Aug. 17, 2022
(86) PCT No.: PCT/EP2022/072972

§ 371 Date: Jan. 5, 2024

(30) Foreign Application Priority Data
Aug. 27, 2021 (CN) 202110997574.0

(51) Int. Cl. C08J 9/12; C08J 9/36

(52) U.S. Cl. CPC C08J 9/122; C08J 9/36; C08J 2201/022; C08J 2375/04

(57) ABSTRACT

Disclosed herein are a process of preparing a polyurethane elastomer foam, a polyurethane elastomer foam prepared by the process, and a method of using the polyurethane elastomer foam.

### TECHNICAL FIELD

The present invention relates to the field of polyurethane elastomer foaming technology, in particular to a process of preparing a polyurethane elastomer foam and a product thereof.

### BACKGROUND

Using foaming technology to form a large number of pores inside the polyurethane (PU) material, thus forming a polyurethane foam material with a porous structure, is an effective means to obtain lightweight products and save materials. The presence of a large number of pores can also endow the material with excellent performances such as thermal insulating, damping and cushioning, noise-reducing and sound-absorbing.

Conventional polyurethane foaming mainly includes three processes of: (1) a prepolymer process, in which a polyol (white material) and an isocyanate (black material) are first mixed and made into a prepolymer, then blowing agent, catalyst(s), surfactant(s), and other additive(s), etc. are added to the prepolymer and mixed under high-speed stirring for foaming, the obtained foam is aged at a certain temperature after curing, to obtain a final product; (2) a semi-prepolymer process, in which a polyol (a white material) and an isocyanate (a black material) are first mixed and made into a prepolymer, then another polyether or polyester polyol and isocyanate, water, a catalyst, a surfactant, other additive(s), etc. are added and mixed under high-speed stirring for foaming; and (3) a one-step process, in which materials such as a polyether or polyester polyol (white material) and an polyisocyanate (black material), water, catalyst(s), surfactant(s), blowing agent(s), other additive(s) are added in one step, and mixed under high-speed stirring for foaming.

However, it is difficult to combine low density with good mechanical properties in polyurethane foams produced by the above processes, because high expansion ratios usually result in reduced mechanical properties and poor skin quality.

Both continuous extrusion molding and injection molding are important technologies for continuous foam molding. However, in the above foaming processes, a raw polymer in a molten state is essential for foaming, which is hardly suitable for industrial mass production. The solid-state foaming process can effectively solve the problem relating to foaming polymer materials with low melt strength. During solid-state foaming, a polymer matrix filled with a blowing agent is heated to a softening region close to the melting point for foaming. For example, when a physical blowing agent such as supercritical N₂ or CO₂ is used, the supercritical fluid is dissolved within the polymer matrix, the fluid reaches a supersaturated state after a rapid increase in temperature, and after pressure-releasing, it induces pore nucleation, promotes pore growth, and realizes foaming of the polymer materials. Solid-state foaming can control the pore size by controlling the temperature, and is suitable for the production of polymer foam materials with special pore diameters such as microcellular foam.

CN105829417A discloses a process for production of expanded thermoplastic elastomer beads, comprising an impregnating step, an expanding step and optionally a fusing step, the produced thermoplastic elastomer beads have an uninterrupted skin, a low density and a uniform pore distribution, and bead expansion and shaped-part production are possible in one operation and in one apparatus.

CN110126171A discloses an integrated foam molding process for polymer particles, comprising steps of: 1) preparing polymer particles with a high-melting point macromolecule resin coated by a low-melting point macromolecule resin; 2) subjecting the polymer particles to one-step foam molding to obtain a foamed product. By preparing polymer particles of a core-shell structure with a high-melting point macromolecule resin coated by a low-melting point macromolecule resin, during the foaming process, the foaming temperature is below the melting point of the core resin, so that foamed beads can be formed at the core of the particles. The foaming temperature is higher than the melting point of the shell resin, the surface is in a molten state. Thus, when the particles are expanded and mutually squeezed, the shell resin in the molten state enables the particles to be fused together. Meanwhile, the particles are in a fluidized state during foaming, the temperatures of all the particles are consistent, the particles are ensured not to be bonded in advance, the internal fusing is uniform and consistent when expansion occurs, filling defects are avoided.

The supercritical foaming process is common in foaming thermoplastic elastomers, such as thermoplastic polyurethane elastomers (TPU). However, as described in the above published applications, this process usually requires a step of making the thermoplastic polyurethane elastomer into particles by an extruder or by other processes before foam molding. The overall process requires many steps and is complex.

Therefore, there is a need for a new foaming process, which combines the requirement on high performance of polyurethane foam products and the requirement on a simple and efficient preparing process.

### DETAILED DESCRIPTION

The present invention provides a polyurethane foaming process, which overcomes the technical problems existing in the above prior art and produces a low-density polyurethane foam product with good physical properties, while the process is simple and efficient.

To this end, the present invention provides the following technical solution:

The invention provides a process of preparing a polyurethane elastomer foam, comprising the steps of:
a) premixing a polyol with an optional additive to obtain a mixed component A;
b) mixing and adding an isocyanate-containing component B and component A into a mold, and closing the mold for reaction to obtain a polyurethane preform;
c) placing the polyurethane preform in a closed cavity, introducing a fluid into the closed cavity until the closed cavity reaches pressure P, at the same time raising the temperature to a first temperature T1, allowing the fluid that has reached a supercritical or near-supercritical state in the cavity to impregnate the polyurethane preform, wherein temperature T1 is in a range of from 80° C. to 190° C., preferably from 90° C. to 160° C., pressure P is in a range of from 5 MPa to 50 MPa, and the impregnation time is from 3 minutes to 6 hours; and
d) releasing the pressure of the closed cavity after reaching the impregnation time, and obtaining the polyurethane elastomer foam material from the polyurethane preform, wherein the pressure-releasing rate is in a range of from 3 MPa/s to 500 MPa/s.

Preferably, the polyol in component A of the above step a) may be a polyether polyol, a polyester polyol, or a mixture thereof.

The polyether polyols used for preparing polyurethanes are obtained by known methods, for example by anionic polymerization of alkylene oxides with addition of at least one starter molecule that contains 2 to 8, preferably 2 to 6 reactive hydrogen atoms in bonded form, in the presence of a catalyst. As the catalyst, alkali metal hydroxides, such as sodium hydroxide or potassium hydroxide, or alkali metal alkoxides, such as sodium methoxide, sodium ethoxide, potassium ethoxide or potassium isopropoxide, may be used; or in the case of cationic polymerization, Lewis acids, such as antimony pentachloride, boron trifluoride etherate or bleaching earth may be used as a catalyst. Furthermore, double metal cyanide compound, which is called DMC catalyst, may also be used as a catalyst.

As alkylene oxides, preference is given to using one or more compounds having 2 to 4 carbon atoms in the alkylene radical, such as ethylene oxide, 1,2-propylene oxide, tetrahydrofuran, 1,2- or 2,3-butylene oxide, in each case alone or in the form of mixtures, and preferably ethylene oxide and/or 1,2-propylene oxide.

Possible starter molecules are, for example, ethylene glycol (MEG), diethylene glycol, glycerol, trimethylolpropane (TMP), pentaerythritol, sugar derivatives, such as sucrose, sugar alcohols, such as sorbitol, methylamine, ethylamine, isopropylamine, butylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine, and other di- or polyhydric alcohols or mono- or polyfunctional amines.

In a preferred embodiment, the polyether polyol further comprises polytetrahydrofuran.

The polyester polyols are usually prepared by condensation of polyols having 2 to 12 carbon atoms, such as ethylene glycol, diethylene glycol, butanediol (BDO), trimethylolpropane, glycerol or pentaerythritol, with polycarboxylic acids having 2 to 12 carbon atoms, such as succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomers of naphthalinedicarboxylic acids, or the anhydrides thereof. The polycarboxylic acids also include other sources of dicarboxylic acids, such as dimethyl terephthalate (DMT), polyethylene terephthalate (PET), and the like.

The polyols used in the present invention further include bio-based polyether and polyester polyols, including but not limited to polyether polyols made from castor oil, palm oil, olive oil, soybean oil, etc.; polyether polyols starting from algae, lignin, etc.; and polyester polyols starting from bio-based dibasic acids such as sebacic acid, succinic acid, bio-based polyols such as ethylene glycol, butylene glycol, propylene glycol.

In addition, the polyether polyols or polyester polyols used in the present invention have a hydroxyl value in a range of from about 20 to about 270 mg KOH/g, preferably from about 28 to about 200 mg KOH/g, more preferably from about 28 to about 150 mg KOH/g, even more preferably from about 28 to about 100 mg KOH/g, most preferably from about 28 to about 80 mg KOH/g.

The polyether polyols or polyester polyols have a molecular weight in a range of from about 500 to about 10,000, preferably from about 600 to about 6,000, more preferably from about 1,000 to about 2,500. Furthermore, the polyether polyols or polyester polyols have a polydispersity index in a specific range, such as in a range of from about 0.8 to about 1.3, preferably from about 0.9 to about 1.2, more preferably from about 0.95 to about 1.1.

Component A may further comprise a crosslinker and/or a chain extender.

As crosslinkers and/or chain extenders, amines or alcohols having two or more functionalities, or mixtures thereof, are used, in particular, for example bifunctional or trifunctional amines and alcohols, in particular diols, triols or mixtures thereof, are used, in each case having a molecular weight of less than 350, preferably from 60 to 300 and in particular from 60 to 250. Here, the bifunctional compounds are called chain extenders and trifunctional or higher-functional compounds are called crosslinkers. It is possible to use, for example, aliphatic, cycloaliphatic and/or aromatic diols having from 2 to 14, preferably from 2 to 10, carbon atoms, e.g., ethylene glycol, 1,2-propanediol, 1,3-propanediol, 1,2-pentanediol, 1,3-pentanediol, 1,10-decanediol, 1,2-dihydroxycyclohexane, 1,3-dihydroxycyclohexane, 1,4-dihydroxycyclohexane, diethylene glycol and triethylene glycol, dipropylene glycol and tripropylene glycol, 1,4-butanediol, 1,6-hexanediol and bis(2-hydroxyethyl) hydroquinone; triols such as 1,2,4-trihydroxycyclohexane, 1,3,5-trihydroxycyclohexane, glycerol and trimethylolpropane; and low molecular weight hydroxyl-containing polyalkylene oxides based on ethylene oxide and/or 1,2-propylene oxide and the abovementioned diols and/or triols as starter molecules.

The chain extender may be an individual compound or a mixture. The chain extender preferably comprises propylene glycol, dipropylene glycol, tripropylene glycol and/or 2,3-butanediol, either alone or optionally in admixture with one another or with further chain extenders.

As crosslinker, preference is given to 1,2,4-trihydroxycyclohexane, 1,3,5-trihydroxycyclohexane, glycerol and/or trimethylolpropane, either alone or optionally in admixture with one another.

According to the present invention, the reaction of forming polyurethane is carried out in the presence of a catalyst, and the catalyst may be optionally added to component A or component B as desired.

As catalysts, it is possible to use all compounds which prompt the isocyanate-polyol reaction. Such compounds are known and are described, for example, in “Kunststoff handbuch, Volume 7, PU”, Carl Hanser-Verlag, 3^{rd} edition, 1993, chapter 3.4.1. These include amine-based catalysts and catalysts based on organic metal compounds.

As catalysts based on organic metal compounds, it is possible to use, for example, organic tin compounds such as tin (II) salts of organic carboxylic acids, e.g., tin (II) acetate, tin (II) octoate, tin (II) ethylhexanoate and tin (II) laurate; and dialkyltin (IV) salts of organic carboxylic acids, such as dibutyltin diacetate, dibutyltin dilaurate, dibutyltin maleate and dioctyltin diacetate; and also bismuth (III) carboxylates, bismuth 2-ethylhexanoate and bismuth octoate, or alkali metal salts of carboxylic acids, e.g., potassium acetate or potassium formate.

As amine-based catalysts, it is possible to use bis(2-dimethylaminoethyl) ether, N, N, N′, N″, N″-pentamethyldiethylenetriamine, 2-(2-diethylaminoethoxy) ethanol, dimethylcyclohexylamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl) hexahydrotriazine, dimethylaminopropylamine, N-ethylmorpholine, diazabicycloundecene and diazabicyclononene.

In component A of the present invention, those skilled in the art can also add any auxiliary and/or additive as desired, including but not limited to pore regulators, fillers, pigments, dyes, antioxidants, hydrolytic stabilizers, antistatic agents, fungicides and bacteriostatic agents, etc.

The isocyanate-containing component B in step b) of the present invention comprises diisocyanates or polyisocyanates, which may be selected from any aliphatic, cycloaliphatic or aromatic isocyanates known to be useful for preparing polyurethanes, including but not limited to diphenylmethane 2,2′-, 2,4′- and 4,4′-diisocyanate, the mixtures of monomeric diphenylmethane diisocyanates (MDI) and diphenylmethane diisocyanate homologs having a greater number of rings (polymeric MDI), isophorone diisocyanate (IPDI) or its oligomers, tolylene diisocyanate (TDI), such as tolylene diisocyanate isomers such as tolylene 2,4- or 2,6-diisocyanate, or a mixture of these, tetramethylene diisocyanate or its oligomers, hexamethylene diisocyanate (HDI) or its oligomers, naphthylene diisocyanate (NDI), or a mixture thereof.

The diisocyanates or polyisocyanates used preferably comprise isocyanates based on diphenylmethane diisocyanate, in particular comprise polymeric MDI. The functionality of the diisocyanates or polyisocyanates is preferably in a range of from 2.0 to 2.9, particularly preferably from 2.1 to 2.8.

The diisocyanates and polyisocyanates can also be used in the form of prepolymers. These prepolymers are obtainable by reacting excessive diisocyanates and/or polyisocyanates as described above with compounds having at least two groups reactive toward isocyanates, for example at a temperature in a range of from 30 to 100° C., preferably 80° C., to give the prepolymer. The NCO content of the diisocyanate prepolymer and/or the polyisocyanate prepolymer of the present invention is preferably in a range of from 10 to 33% by weight of NCO, particularly preferably in a range of from 15 to 28% by weight of NCO.

In the present invention, neither component A nor component B comprises an additional blowing agent.

In step b) of the present invention, the polyurethane preform may be molded by injection or casting. The mixture of component A and component B may be added into the mold by injection or casting. In contrast to the granulation process of thermoplastic polyurethane, the polyurethane preform used in the present invention is directly molded after liquid mixing. The processing technology is more flexible and simpler, and the production efficiency is higher.

In a preferred embodiment of the present invention, the polyurethane preform obtained in step b) has a hardness of not greater than 80 Shore A, preferably in a range of from 10 to 80 Shore A, more preferably from 20 to 80 Shore A, further preferably from 45 to 75 Shore A.

In step c) of the present invention, the preferred closed cavity is a pressure vessel resistant to high temperature and high pressure, such as an autoclave reactor. The required pressure and the necessary temperature are dependent on the used polyurethane preform, the used auxiliary material, the used fluid, and the mixing ratio between the components.

Any fluid known to those skilled in the art can be used for impregnation, preferably an inert gas such as argon, nitrogen or carbon dioxide, particularly preferably carbon dioxide or nitrogen or a mixture thereof.

The fluid used as blowing agent is particularly preferably a mixture of CO₂ and N₂. In principle, any mixing ratio of CO₂ to N₂ is usable. For example, it is preferable to use a mixed blowing agent including 50% to 100% by weight of carbon dioxide and 0% to 50% by weight of nitrogen. It is particularly preferred that the blowing agent comprises only CO₂, N₂ or a mixture of these two gases, with no other blowing agent. Alternatively, it is preferable to use a mixed blowing agent comprising 50 to 100 wt % of nitrogen and 0 to 50 wt % of carbon dioxide.

In step c) of the present invention, the temperature is set in a range of from 80° C. to 190° C., and the pressure P is set in a range of from 5 MPa to 50 MPa, allowing the fluid that has reached a supercritical or near-supercritical state in the cavity to impregnate the polyurethane preform. The impregnation of the fluid to the polyurethane preform can reach saturation. Impregnation saturation refers to impregnation in a high-pressure fluid atmosphere until the high-pressure fluid and the polyurethane preform reach a dissolution equilibrium. The impregnation time is usually in a range of from 3 minutes to 6 hours.

In a preferred embodiment, pressure P is set in a range of from 10 MPa to 18 MPa, and the impregnation time is in a range of from 3 minutes to 2 hours, preferably in a range of from 30 minutes to 90 minutes.

In step d) of the present invention, the preform is foam-molded by releasing the pressure, and the pressure-releasing rate is in a range of from 3 MPa/s to 500 MPa/s. Preferably, the rate is in a range of from 4 MPa/s to 100 MPa/s, more preferably from 5 MPa/s to 30 MPa/s.

Optionally, after releasing the pressure in step d), the process further comprises step e) of cooling at a temperature in a range of from 0 to 25° C.

Optionally, the polyurethane elastomer foam material obtained in step d) or e) is placed in a mold for further hot pressing.

Optionally, the polyurethane elastomer foam material obtained in step d) or e) is further cut into the desired size.

In a preferred embodiment of the process, the foaming of the polyurethane preform in step d) is partial, which means that the pressure at the first temperature T1 is reduced to a pressure that is that is higher than ambient pressure, and the density of the partially foamed polyurethane preform is greater than the density of the polyurethane elastomer foam material that can be obtained by reducing the pressure to ambient pressure.

Preferably, in a further foaming step d2), the partially foamed polyurethane preform is subsequently fully expanded at second temperature T2, for which purpose the pressure at the second temperature T2 is reduced until a desired density is obtained. The desired density is more preferably obtained when the pressure at the second temperature T2 is reduced to ambient pressure. Foaming step d2) can be carried out in the same device or in another device than the one for foaming step d).

In the present invention, foaming by supercritical fluid is a method in which a fluid is injected into a closed cavity loaded with a polyurethane preform material, and is brought into a supercritical or near-supercritical state after reaching a certain temperature and pressure, wherein the obtained system is maintained at this state for a certain period of time, such that the supercritical/near-supercritical fluid penetrates into the polyurethane preform to form a polymer/fluid homogeneous system, and the equilibrium state of the polymer/fluid homogeneous system inside the material is destroyed by reducing the pressure at a certain rate, thereby forming bubble nuclei inside the material, then the bubble nuclei grows and takes a shape to obtain a foamed material; wherein increasing the pressure can improve the solubility of the fluid in the polymer, and then the number of bubble nuclei increases, and the pore density increases; with the increase in pressure drop, the rate of bubble nucleation increases, and more bubble nuclei are formed; the fluid concentration gradient inside and outside the bubble or the pressure difference between the inside and the outside is the driving force for pore growth, the pressure-releasing rate directly affects the acceleration of pore growth, and increasing the pressure-releasing rate is beneficial to decrease the pore diameter and increase the pore density; above the glass transition temperature, the lower the saturation temperature is, the higher the solubility of the fluid in the polymer will be, and thus the higher the nucleation rate and the higher the nucleation density will be. The final product can meet the requirement of lightweight, and the density can be in a range of from 0.05 g/cm³ to 0.50 g/cm³, preferably from 0.10 g/cm³ to 0.35 g/cm³. The processed foam may have a hardness in a range of from 10 to 70 Asker C, preferably from 10 to 65 Asker C, more preferably from 10 to 50 Asker C, still more preferably from 20 to 45 Asker C.

The present invention also provides the use of polyurethane elastomer foams.

Preferably, the polyurethane elastomer foam is used in the field of transportation, furniture, sports products or shoe materials.

Preferably, the polyurethane elastomer foam is used for seat.

Preferably, the polyurethane elastomer foam is used for sole.

By using the process of the present invention, the polyurethane elastomer preform is made into a foamed material through a supercritical fluid foam-molding process. The obtained foamed material has better physical properties than the polyurethane foam foamed with a chemical blowing agent under the same density. It can be used in the field of transportation, such as vehicle seats, car interiors, armrests, etc., and in the field of furniture, such as cushioning materials, various cushion laminate composite materials, and can also be used as sound-insulation materials, filter materials, decorative materials, shockproof materials, packaging materials and thermal-insulation materials, etc., and it can also be used in the application fields of sports products, shoe materials, etc., such as helmets, protective gears, soles, insoles, sports auxiliary equipment and the like. In the preparation of shoe material products, especially the sole materials, the shoes are endowed with a lighter weight, high resilience and excellent physical properties, which can give the shoe wearer a better comfort experience; at the same time, compared with the process wherein thermoplastic polyurethane is firstly granulated and then foamed, the process of the present invention is much simpler, requires milder conditions and a shorter production line, achieves a high efficiency, and also is green and environmentally friendly, and suitable for large-scale industrial production.

### EMBODIMENTS

The following examples are provided for a better understanding of the present invention, and are not limited to the best mode for carrying out the invention, and do not limit the content and protection scope of the present invention. The protection scope of the present invention still extends to the technical solutions claimed in the claims of the present invention and any appropriate adjustments and modifications that are embodied in the present invention.

In the description of the present invention, it is to be noted that the orientation or positional relationship indicated by the terms “center”, “upper”, “lower”, “left”, “right”, “vertical”, “horizontal”, “inside”, “outside”, etc. is based on the orientation or positional relationship, the terms are only used for the convenience of describing the present invention and simplifying the description, rather than indicating or implying that the indicated device or element must have a specific orientation, or must be constructed and operated according to a specific orientation, and therefore shall not be construed as having any limitation on the present invention. Furthermore, the terms “first”, “second”, and “third” are used for descriptive purposes only and shall not be construed to indicate or imply the relative importance.

In the description of the present invention, it is to be noted that unless otherwise specified and limited, the terms “installed”, “linked”, and “connected” shall be understood broadly. For example, the connection may be a fixed connection or a detachable connection, or an integrated connection; it may be a mechanical connection or an electrical connection; it can be a direct connection or an indirect connection through an intermediate medium, and it can be the internal communication between two elements. For those of ordinary skill in the art, the specific meanings of the above terms in the present invention can be understood depending on specific situations.

If specific experimental steps or conditions are not specified in the examples, they can be carried out according to the operations or conditions used for conventional experimental steps as described by the literatures in the art. The starting materials or instruments used without any indication of their manufacturers are all conventional products that are commercially available.

The test methods used in the present invention are as follows:
Density (g/cm³): ISO 1183-1
Hardness (Asker C): JIS S 6050
Hardness (Shore A): DIN ISO 7619-1
Tensile strength (MPa): DIN 53504
(Break) Elongation (%): DIN 53504
Tear (kg/cm): ISO 1183-1
Split tear (kg/cm): SATRA TM 411
Rebound (%): ASTM D 2632

Among the raw materials that used, the isocyanate prepolymers are as follows:

TABLE 1

| | Isocyanate | | NCO |
|---|---|---|---|
| Ingredient | Monomer | Polyol | wt % |
| Isocyanate Prepolymer 1 | MDI | Polyester Polyol 1, | 18.9 |
| | | Polyester Polyol 2 | |
| Isocyanate Prepolymer 2 | MDI | Polyether Polyol 1 | 18.2 |
| Isocyanate Prepolymer 3 | MDI | Polyether Polyol 1 | 26.2 |
| Isocyanate Prepolymer 4 | MDI | Polyester Polyol 1, | 12 |
| | | Polyester Polyol 2 | |
| Isocyanate Prepolymer 5 | MDI | Polyether Polyol 1 | 29.5 |

The polyols are as follows:

TABLE 2

| | | Weight average | |
|---|---|---|---|
| | | molecular weight | |
| Ingredient | Monomer | (g/mol) | Functionality |
| Polyester | Diethylene glycol, ethylene | 1400 | 2 |
| Polyol 1 | glycol, adipic acid | | |
| Polyester | Ethylene glycol, glycerol, | 2500 | 2.6 |
| Polyol 2 | adipic acid | | |
| Polyether | Tetrahydrofuran | 2000 | 2 |
| Polyol 1 | | | |

The amine-based catalyst is Dabco EG, purchased from Evonik.

The tin-based catalyst is Fomrez UL-28, purchased from Huntsman.

The silicone oil is Dabco DC 193, purchased from Evonik.

### Example 1

### Component A

TABLE 3

| Ingredient | Parts (by weight %) |
|---|---|
| Polyester Polyol 1 | 85 |
| Polyester Polyol 2 | 10 |
| BDO | 4.5 |
| Amine-based catalyst | 0.495 |
| Tin-based catalyst | 0.005 |

### Component B: Isocyanate Prepolymer 1

Component A and component B were fully mixed with the ratio of 100:52 by weight percentage, then poured into a mold, and demolded after 10 minutes of reaction to obtain a non-foamed polyurethane preform having a hardness of 55 Shore A. The obtained polyurethane preform was placed in a closed cavity, to this closed cavity carbon dioxide gas was introduced until 10 MPa was reached, and the temperature was elevated to 120° C. at the same time, allowing the supercritical carbon dioxide in the cavity to impregnate the polyurethane preform for an impregnation time of 60 minutes. After reaching the impregnation time, the pressure was released for expanding and foam molding, giving a polyurethane foam material, wherein the pressure-releasing rate was 10 MPa/s.

### Comparative Example 1

### Component A

TABLE 4

| Ingredient | Parts (by weight %) |
|---|---|
| Polyester Polyol 1 | 83.6 |
| Polyester Polyol 2 | 9.9 |
| BDO | 4.4 |
| Water (blowing agent) | 1.3 |
| Amine-based catalyst | 0.495 |
| Tin-based catalyst | 0.005 |
| Silicone oil | 0.3 |

### Component B: Isocyanate Prepolymer 1

Component A and component B were fully mixed in the ratio of 100:83.1 by weight, then poured into a mold, and demolded after 10 minutes of reaction to obtain a polyurethane foam material.

TABLE 5

| | Example 1 | Comparative Example 1 |
|---|---|---|
| Density (g/cm³) | 0.19-0.21 | 0.19-0.22 |
| Hardness (Asker C) | 20-28 | 20-28 |
| Tensile strength (MPa) | 3.5 | 0.8 |
| Elongation (%) | 460 | 160 |
| Tear (kg/cm) | 12 | 5 |
| Split tear (kg/cm) | 3.2 | 0.5 |
| Rebound (%) | 55 | 40 |

### Example 2

### Component A

TABLE 6

| Ingredient | Parts (by weight %) |
|---|---|
| Polyether Polyol 1 | 97 |
| MEG | 2 |
| Amine-based catalyst | 1.0 |

### Component B: Isocyanate Prepolymer 2

Component A and component B were fully mixed in the ratio of 100:37.7 by weight, then poured into a mold, and demolded after 10 minutes of reaction to obtain a non-foamed polyurethane preform having a hardness of 63 Shore A. The obtained polyurethane preform was placed in a closed cavity, to the closed cavity carbon dioxide gas was introduced until 12 MPa was reached, and the temperature was elevated to 140° C. at the same time, allowing the supercritical carbon dioxide in the cavity to impregnate the polyurethane preform for an impregnation time of 60 minutes. After reaching the impregnation time, the pressure was released for expanding and foam molding, giving a polyurethane foam material, wherein the pressure-releasing rate was 10 MPa/s.

### Comparative Example 2

### Component A

TABLE 7

| Ingredient | Parts (by weight %) |
|---|---|
| Polyether Polyol 1 | 95.1 |
| MEG | 1.9 |
| Water (blowing agent) | 1.7 |
| Amine-based catalyst | 1.0 |
| Silicone oil | 0.3 |

### Component B: Isocyanate Prepolymer 2

Component A and component B were fully mixed in the ratio of 100:80.1 by weight, then poured into a mold, and demolded after 10 minutes of reaction to obtain a polyurethane foam material.

TABLE 8

| | Example 2 | Comparative Example 2 |
|---|---|---|
| Density (g/cm³) | 0.15-0.16 | 0.15-0.16 |
| Hardness (Asker C) | 40-41 | 40-41 |
| Tensile strength (MPa) | 3.2 | 1.5 |
| Elongation (%) | 470 | 390 |
| Tear (kg/cm) | 11 | 6 |
| Split tear (kg/cm) | 2.5 | 1.3 |
| Rebound (%) | 70 | 50 |
| Appearance | Good skin, no peeling | Peeling |

### Example 3

### Component A

TABLE 9

| Ingredient | Parts (by weight %) |
|---|---|
| Polyether Polyol 1 | 91.5 |
| MEG | 4 |
| BDO | 3 |
| TMP | 0.45 |
| Amine-based catalyst | 1.0 |
| Tin-based catalyst | 0.05 |

### Component B: Isocyanate Prepolymer 3

Component A and component B were fully mixed in the ratio of 100:52.8 by weight, then poured into a mold, and demolded after 15 minutes of reaction to obtain a non-foamed polyurethane preform having a hardness of 80 Shore A. The obtained polyurethane preform was placed in a closed cavity, to the closed cavity carbon dioxide gas was introduced until 12 MPa was reached, and the temperature was elevated to 140° C. at the same time, allowing the supercritical carbon dioxide in the cavity to impregnate the polyurethane preform for an impregnation time of 60 minutes. After reaching the impregnation time, the pressure was released for expanding and foam molding, giving a polyurethane foam material, wherein the pressure-releasing rate was 10 MPa/s.

### Comparative Example 3

### Component A

TABLE 10

| Ingredient | Parts (by weight %) |
|---|---|
| Polyether Polyol 1 | 89 |
| MEG | 4 |
| BDO | 3 |
| TMP | 0.45 |
| Water | 2.0 |
| Amine-based catalyst | 1.0 |
| Tin-based catalyst | 0.05 |
| Silicone oil | 0.5 |

### Component B: Isocyanate Prepolymer 3

Component A and component B were fully mixed in the ratio of 100:91.5 by weight, then poured into a mold, and demolded after 15 minutes of reaction to obtain a polyurethane foam material.

TABLE 11

| | Example 3 | Comparative Example 3 |
|---|---|---|
| Density (g/cm³) | 0.18-0.20 | 0.18-0.20 |
| Hardness (Asker C) | 43-44 | 43-44 |
| Tensile strength (MPa) | 3.6 | 1.7 |
| Elongation (%) | 430 | 370 |
| Tear (kg/cm) | 12 | 6.5 |
| Split tear (kg/cm) | 3.4 | 1.5 |
| Rebound (%) | 65 | 40 |
| Appearance | Good skin, no peeling | Peeling |

### Example 4

### Component A

TABLE 12

| Ingredient | Parts (by weight %) |
|---|---|
| Polyester Polyol 1 | 88.5 |
| Polyester Polyol 2 | 10 |
| BDO | 1 |
| Amine-based catalyst | 0.495 |
| Tin-based catalyst | 0.005 |

### Component B: Isocyanate Prepolymer 4

Component A and component B were fully mixed in the ratio of 100:45 by weight, then poured into a mold, and demolded after 10 minutes of reaction to obtain a non-foamed polyurethane preform having a hardness of 25 Shore A. The obtained polyurethane preform was placed in a closed cavity, to the closed cavity carbon dioxide gas was introduced until 10 MPa was reached, and the temperature was elevated to 120° C. at the same time, allowing the supercritical carbon dioxide in the cavity to impregnate the polyurethane preform for an impregnation time of 60 minutes. After reaching the impregnation time, the pressure was released for expanding and foam molding, giving a polyurethane foam material, wherein the pressure-releasing rate was 10 MPa/s.

### Comparative Example 4

### Component A

TABLE 13

| Ingredient | Parts (by weight %) |
|---|---|
| Polyester Polyol 1 | 86.8 |
| Polyester Polyol 2 | 9.9 |
| BDO | 1 |
| Water (blowing agent) | 1.5 |
| Amine-based catalyst | 0.495 |
| Tin-based catalyst | 0.005 |
| Silicone oil | 0.3 |

### Component B: Isocyanate Prepolymer 4

Component A and component B were fully mixed in the ratio of 100:100 by weight, then poured into a mold, and demolded after 10 minutes of reaction to obtain a polyurethane foam material.

TABLE 14

| | Example 4 | Comparative Example 4 |
|---|---|---|
| Density (g/cm³) | 0.19-0.21 | 0.19-0.22 |
| Hardness (Asker C) | 10-15 | 12-16 |
| Tensile strength (MPa) | 3.5 | 0.8 |
| Elongation (%) | 310 | 105 |
| Tear (kg/cm) | 6 | 2.5 |
| Split tear (kg/cm) | 2.2 | 0.5 |
| Rebound (%) | 45 | 35 |

### Comparative Example 5

### Component A

TABLE 15

| Ingredient | Parts (by weight %) |
|---|---|
| Polyether Polyol 1 | 89.5 |
| MEG | 7 |
| BDO | 2 |
| TMP | 0.45 |
| Amine-based catalyst | 1.0 |
| Tin-based catalyst | 0.05 |

### Component B: Isocyanate Prepolymer 5

Component A and component B were fully mixed in the ratio of 100:50 by weight, then poured into a mold, and demolded after 15 minutes of reaction to obtain a non-foamed polyurethane preform having a hardness of 90 Shore A. The obtained polyurethane preform was placed in a closed cavity, to the closed cavity carbon dioxide gas was introduced until 12 MPa was reached, and the temperature was elevated to 140° C. at the same time, allowing the supercritical carbon dioxide in the cavity to impregnate the polyurethane preform for an impregnation time of 60 minutes. After reaching the impregnation time, the pressure was released for expanding and foam molding, giving a polyurethane foam material, wherein the pressure-releasing rate was 10 MPa/s.

TABLE 16

| | Comparative Example 5 |
|---|---|
| Density (g/cm³) | 0.55 |
| Hardness (Asker C) | 65-75 |
| Foaming characteristics | Poor foaming |

From Table 17, it can be observed that each of the polyurethane preforms in Examples 1 to 4 has a hardness of below 80, and the foams obtained after foaming have uniform pores and relatively stable production. However, the hardness of the preform in Comparative Example 5 exceeds Shore A 80, the foaming performance is poor, the pores are not uniform, and the production is also unstable.

TABLE 17

| | | | | | Comparative |
|---|---|---|---|---|---|
| | Example 1 | Example 2 | Example 3 | Example 4 | Example 5 |
| Preform | 55 | 63 | 80 | 25 | 90 |
| hardness | | | | | |
| (Shore A) | | | | | |
| Foaming | 0.19-0.21 | 0.15-0.16 | 0.18-0.20 | 0.19-0.21 | 0.55 |
| density | | | | | |
| (g/cm³) | | | | | |
| Foam | 20-28 | 40-41 | 43-44 | 10-15 | 65-75 |
| hardness | | | | | |
| (Asker C) | | | | | |
| Pore | Uniform | Uniform | Uniform | Uniform | Non-uniform |
| uniformity | | | | | |
| Production | Relatively | Stable | Stable | Relatively | Unstable |
| stability | stable | | | stable | |

1. A process of preparing a polyurethane elastomer foam, comprising the steps of:
a) premixing a polyol with an optional additive to obtain a mixed component A;
b) mixing and adding an isocyanate-containing component B and component A into a mold, and closing the mold for reaction to obtain a polyurethane preform;
c) placing the polyurethane preform in a closed cavity, introducing a fluid into the closed cavity until the closed cavity reaches pressure P, at the same time raising the temperature to a first temperature T1, allowing the fluid that has reached a supercritical or near-supercritical state in the cavity to impregnate the polyurethane preform, wherein temperature T1 is in a range of from 80° C. to 190° C., pressure P is in a range of from 5 MPa to 50 MPa, and the impregnation time is in a range of from 3 minutes to 6 hours; and
d) releasing the pressure of the closed cavity after reaching the impregnation time, and obtaining a polyurethane elastomer foam material from the polyurethane preform, wherein the pressure-releasing rate is in a range of from 3 MPa/s to 500 MPa/s.

2. The process of preparing a polyurethane elastomer foam according to claim 1, wherein the pressure P is in a range of from 10 MPa to 18 MPa, and the impregnation time is in a range of from 3 minutes to 2 hours.

3. The process of preparing a polyurethane elastomer foam according to claim 1, wherein the pressure-releasing rate is in a range of from 4 MPa/s to 100 MPa/s.

4. The process of preparing a polyurethane elastomer foam according to claim 1, wherein the fluid comprises at least one of nitrogen gas and carbon dioxide.

5. The process of preparing a polyurethane elastomer foam according to claim 4, wherein the nitrogen in the fluid is not less than 50% by weight.

6. The process of preparing a polyurethane elastomer foam according to claim 1, wherein the mixture of component A and component B is added into the mold by injection or casting.

7. The process of preparing a polyurethane elastomer foam according to claim 1, wherein neither component A nor component B comprises an additional blowing agent.

8. The process of preparing a polyurethane elastomer foam according to claim 1, wherein the polyurethane preform has a hardness of not greater than 80 Shore A.

9. The process of preparing a polyurethane elastomer foam according to claim 1, comprising, after releasing the pressure in step d), a step e) of cooling at a temperature in a range of from 0 to 25° C.

10. The process of preparing a polyurethane elastomer foam according to claim 1, wherein the polyurethane elastomer foam material obtained in step d) or e) is placed in a mold for further hot pressing.

11. The process of preparing a polyurethane elastomer foam according to claim 1, wherein the polyurethane elastomer foam material obtained in step d) or e) is further cut into a desired size.

12. The process of preparing a polyurethane elastomer foam according to claim 1, wherein the foaming of the unformed polyurethane preform in step d) is partial, wherein the pressure at the first temperature T1 is reduced to a pressure that is higher than ambient pressure, and the density of the partially foamed polyurethane preform is greater than the density that can be obtained by reducing the pressure to ambient pressure.

13. The process of preparing a polyurethane elastomer foam according to claim 12, further comprising a foaming step d2), wherein the partially foamed polyurethane preform is subsequently fully expanded at a second temperature T2, and then the pressure in the cavity is reduced to such an extent that the pressure at the second temperature T2 is reduced until a desired density is obtained.

14. The process of preparing a polyurethane elastomer foam according to claim 13, wherein foaming step d2) is carried out in the same device or in another device than the one for foaming step d).

15. A polyurethane elastomer foam prepared by the process of preparing a polyurethane elastomer foam according to claim 1.

16. (canceled)

17. A method of using the polyurethane elastomer foam according to claim 15, wherein the method comprises using the polyurethane elastomer foam in the field of transportation, furniture, sports products or shoe materials.

18. A method of using the polyurethane elastomer foam according to claim 17, wherein the method comprises using the polyurethane elastomer foam for a seat.

19. A method of using the polyurethane elastomer foam according to claim 17, wherein the method comprises using the polyurethane elastomer foam for a sole.

20. The process of preparing a polyurethane elastomer foam according to claim 1, wherein in the temperature T1 in step c) is in a range of from 90° C. to 160° C.

21. The process of preparing a polyurethane elastomer foam according to claim 2, wherein the impregnation time is in a range of from 30 minutes to 90 minutes.
